(19) United States
(12) Patent Application Publication
(10) Pub. No.: US 2005/0001481 A1
(43) Pub. Date: Jan. 6, 2005

(54) Method for holding a vehicle on an incline and starting traction control for holding a vehicle on an incline

(76) Inventors: Ronald Kley, Seligenstadt (DE); Rainer Klusemann, Main (DE)

Correspondence Address: Gerlinde M Nattler;Continental Teves Inc, One Continental Drive, Auburn Hills, MI, 48326, US

(21) Appl. No.: 10/477,304

(22) PCT Filed: Apr. 30, 2002
(86) PCT No.: PCT/EP02/04755

(30) Foreign Application Priority Data
May 9, 2001 (DE) 101 22 580.6

(51) Int. Cl. B60T 8/32

(52) U.S. Cl. 303/191

(57) ABSTRACT

A method for holding a vehicle on an incline by metering brake pressure into the wheel brakes of a brake system, and a starting aid perform the following steps: a) determining the brake pressure (p1) required to hold the vehicle
b1) determining a time period dt according to a reduction of the brake pressure, in particular due to leakage of the brake system starting from the release of the brake pedal (3), or
b2) comparing the determined brake pressure with the actual brake pressure starting from the release of the brake pedal (3), and c) increase of the brake pressure in the wheel brakes by
   c1) switching on a pressure generator (6, 7)
   c2) opening the on-off valve (20, 20′)
   c3) controlling a valve (8, 8′) in such a fashion that at least the brake pressure (p1, p2) required to hold the vehicle will develop in the wheel brakes.

### BACKGROUND OF THE INVENTION

The present invention relates to a method and a starting aid for holding a vehicle on an incline by metering brake pressure into the wheel brakes of a brake system.

Methods for holding the brake pressure applied by the driver and corresponding brake pressure holding devices in connection with starting aids are known in the art. A starting aid is a comfort-oriented assistance function meant to relieve the driver when starting to drive on an incline.

The driver is given assistance when the starting maneuver is initiated at standstill in such a manner that the vehicle is retained in a braked state on an incline and the driver can release a previously applied brake device in order to start driving without the vehicle rolling away uncontrolled. This feature bridges the period between the release of a brake and the actual starting maneuver. Methods for holding the driver's brake pressure are known which actively build up and hold brake pressure, brake torque or brake force by means of an active service brake. This active brake intervention occurs when activation criteria of a starting aid are satisfied. For brake systems such as an electrohydraulic or electromechanical brake, electric parking brake, or a brake system with active brake booster it is per se not a problem to hold the brake pressure because these brake systems are equipped with an actuatable extraneous pressure generator, meaning a pressure source independent of the driver.

Active brake pressure build-up takes place in a starting aid when the vehicle is at standstill because the starting aid will only be activated at standstill. Starting aids with brake systems equipped with an ESP or TCS control comprise actuatable valves and a motor-and-pump assembly. In general, it is possible to precisely adjust the holding brake pressure in these brake systems on the basis of pressure sensors associated with the master brake cylinder.

In addition, attempts have been made to hold the brake pressure in these brake systems by means of an actuatable shut-off valve in the brake line. In this arrangement, the connection between the brake line and the master brake cylinder is closed, and the brake fluid is shut up in the brake line at the value of the ‘holding brake pressure’ introduced by the driver. The separating valves used in TCS and ESP brake systems are appropriately used as shut-off valves, which must be switched from their non-energized open basic position into their energized closed switch position as soon as the activation criteria are satisfied.

The starting maneuver itself is ascertained by way of a suitable assessment of vehicle data and quantified as drive torque that is conducted to the driving wheels by way of the clutch. The starting aid will then assist in the starting maneuver by reducing the brake torque in dependence on the drive torque prevailing at the driving wheels. When the driver builds up sufficient drive torque on the driving wheels by means of the clutch, the starting aid will reduce the brake torque to zero until the driver initiates further system activation (WO 99/20921).

The pressure-holding time or starting-aid assistance time of these starting aids can be highly limited in time (e.g. a maximum of some seconds) when leakages occur at hydraulic components such as valves, pumps and at the master brake cylinder, due to which leakages the holding brake pressure during the starting-aid assistance time is reduced. In the event of a considerable extension of the pressure holding time or starting-aid assistance time, for example to up to four minutes, provisions must always be made for a control of the brake pressure with an active pressure increase on account of the above-noted hydraulic leakage at the hydraulic components in order to reliably prevent the vehicle from undesirably rolling away on a slope. This purpose would necessitate pressure sensors in both brake circuits, thereby entailing additional costs.

An object of the present invention is to provide a preferably low-cost method for holding the driver's brake pressure for a longer time period, and a corresponding starting aid.

After a model-based detection of pressure losses (‘worst-case’ calculation) due to leakages at the individual hydraulic components, it is possible in hydraulic brake systems to control the discrepancies determined from these pressure losses between the necessary brake pressure and the ‘actual brake pressure’ prevailing in the wheel brakes as a function of time by means of the hydraulic pump. If, however, the ‘actual brake pressures’ in the two brake circuits are not measured, the result for brake systems with so-called ‘switching valves’ (on/off valves) will be that due to the ‘worst-case’ calculation the actual brake pressure will be more or less in excess of the actually required brake pressure. As this occurs, the brake pressure may reach a quantity that will open the pressure relief valve that secures the inlet valve of the brake system. Yet the higher the system pressure is, the higher the wear of the hydraulic components of the brake system may become and the higher the noise emission will be. In addition, the comfort offered by the starting aid is impaired as the excessively high brake pressure will impart the impression to the driver in the starting maneuver that the vehicle is still held stationary, while it should be starting to drive already in the chronological order of functions.

### SUMMARY OF THE INVENTION

According to the invention, this object is achieved in that the following steps are executed in a generic method:
a) determining the brake pressure (p1) required to hold the vehicle.
b1) determining a time period dt according to a reduction of the brake pressure, in particular due to leakage of the brake system, starting from the release of the brake pedal, or
b2) comparing the determined brake pressure with the actual brake pressure starting from the release of the brake pedal, and
c) increase of the brake pressure in the wheel brakes by
   c1) switching on a pressure generator
   c2) opening the change-over valve
   c3) controlling at least one valve in such a fashion that at least the brake pressure (p1, p2) required to hold the vehicle develops in the wheel brakes.

This feature renders it possible to control the holding brake pressure, at reducing brake pressures in the wheel brakes after release of the brake pedal due to leakage/pressure losses at the individual hydraulic components, towards a value which at least corresponds to the holding brake pressure and maximally allows only one discrepancy in its increase, the discrepancy being determined by a tolerance field of the controlled valves. In this case it is unnecessary to arrange pressure sensors in the brake circuits because the control is started by way of the model-based determination of the pressure losses as a function of time either after an estimated time period (feature b1) or after a comparison of the determined brake pressure with ‘real’ or actual pressures reduced by the pressure losses (feature b2) which may e.g. be stored in a table or the like.

Another objective of the present invention is to design a generic starting aid with a separating valve in such a manner that the separating valve is configured as an analog or analogized valve and is actuatable by way of an actuating current in such a way that it is at least adjustable to a value of brake pressure (p1,p2) lying on the holding brake pressure (p1) in dependence on a holding brake pressure determined on a slope according to a functional correlation (valve actuating current (I)/pressure (P)) when the pedal is released.

Slide valves, proportional valves or, preferably, analogized switch valves are used as analog or analogized valves.

Analogized separating valves operate similarly as on-off valves, with the difference that with the adjusted valve current a pressure difference defined in a tolerance window is also adjusted on the valve. If, according to the model-based ‘worst-case’ calculation, the leakage or the pressure loss is determined as a function of time, it is thus possible to fix the point of time of the control after release of the brake pedal. When the hydraulic pump is switched on for pressure increase and, simultaneously, the actuating current of the analogized separating valve is adjusted according to the necessary hydraulic pressure, the brake pressure introduced into the wheel brakes can rise maximally slightly with respect to the wanted nominal brake pressure in dependence on the scattering of the analogized separating valve. The analogized separating valve will adopt the function of an adjustable pressure limiting valve in this case.

Therefore, it is expedient to employ an analog or analogized separating valve as a controllable pressure limiting valve in a brake system for vehicles. It is preferred that the brake system includes the starting aid function and is used as a starting aid.

It is favorable that for determining the brake pressure (p1) necessary for holding, the brake pressure that is introduced by the driver into the wheel brakes by way of brake pedal application or by way of an independent pressure source is sensed by a pressure sensor or estimated by way of a model.

The holding brake pressure determined by the pressure sensor is stored in an electric or electronic memory according to the invention.

A brake light switch, a release switch at the brake pedal, or the assessment of the pressure gradient determined by the pressure sensor allows detecting the release of the brake pedal that is expedient for the method in order to determine the point of time commencing which an automatic reduction of the holding brake pressure occurs.

Further, it is favorable that the brake pressure reduced in the wheel brakes is re-increased in the wheel brake within a time period that is in a functional relationship to the necessary holding brake pressure (p1).

Favorably, the method and the starting aid arrange for that at least one analog or analogized valve is so controlled towards the holding brake pressure (p1) during the increase of brake pressure by way of the activated pressure generator that the brake pressure (p1, p2) introduced into the wheel brakes lies at or above the bottom valve current/pressure characteristic curve and within the deviation predetermined by a tolerance field of the analog or analogized valve.

Further, it may be favorable that a maximum brake pressure introduced into the wheel brakes is adjusted in accordance with the top valve current/pressure characteristic curve of the tolerance field of the analog or analogized valves.

In order that the vehicle is always safely retained on a slope by means of the starting aid when the driver releases the service brake to start driving, it is necessary to shut up the maximum brake pressure adjusted by the driver in the brake as well. To this end, it is favorable to energize the separating valve according to the actuating current/pressure characteristic curve of the analogized separating valve already before activating the starting aid, when the driver is still applying the service brake. For this purpose, the actuating current is chosen to be below the current/pressure characteristic curve in order that the driver does not feel any negative influence by the ‘closed’ separating valve (e.g. corresponding to the current/pressure characteristic curve ‘C’ of the analogized separating valve).

It is possible to calculate the gradient of the slope by determining the holding brake pressure (p1) in a model to which are sent, as an input quantity, the signals of a longitudinal acceleration sensor. The holding brake pressure can be determined from the gradient of the slope in a known manner.

According to a preferred embodiment, the holding brake pressure (p1) is determined by means of a pressure sensor sensing the brake pressure introduced by the driver into the wheel brake(s) when holding the vehicle.

It is advantageous that the holding brake pressure (p1) is stored in a memory and, upon release of the pedal, is compared with brake pressures (p_{red}) stored in a table and representing the brake pressures reduced by the leakage losses, and that the pump is switched on and the analog or analogized separating valve is adjusted to the holding brake pressure (p1, p2) when the reduced brake pressure (p_{red}) has reached a predetermined value.

It is furthermore expedient that the control unit includes a timer or counter, that the value of the timer or counter is increased starting from release of the brake pedal, and that the pump is switched on, the change-over valve is opened, and the analog or analogized separating valve is adjusted to the holding brake pressure (p1, p2) when the timer or counter has reached or exceeded a predetermined value (wₗᵢₘᵢₜ).

Suitably, the magnitude of the value (wₗᵢₘᵢₜ) is predetermined in response to the holding brake pressure.

Advantageously, the method or the starting aid do not require additional pressure signals or pressure sensors for monitoring the wheel pressure level.

In addition, there is no risk in the method of the starting aid that the brake pressure will reach excessively high pressure levels in an uncontrolled manner, thus impairing the comfort of the starting aid and increasing the wear of the hydraulic components.

Favorable improvements will be described in detail in the following.

### BRIEF DESCRIPTION OF THE DRAWINGS

In the drawings,

FIG. 1 shows a hydraulic circuit diagram of the brake system.

FIG. 2 is a diagram showing the pressure/current characteristic curves of an analogized separating valve.

FIG. 3 is a diagram showing the brake pressure values/actuating currents of the separating valves.

FIG. 4 is a flow chart plotting the process run of the starting aid.

### DETAILED DESCRIPTION OF THE DRAWINGS

The brake system comprises a master cylinder connected to a supply reservoir 2 and operable by a brake pedal 3. Extending from master cylinder 1 are two brake lines 4 and 5 respectively feeding a brake circuit I or II. At least one brake line 4 has below the master cylinder 1 a pressure sensor 27, which is used to determine the driver's desire to brake the vehicle. For example, it is determined by way of a brake light switch at the brake pedal 3 whether or not braking is effected by brake pedal 3. The two brake circuits I and II have an identical design. Their return pumps 6 and 7 can have a joint driving motor.

The description of brake circuit I that is following now applies equally to brake circuit II. Brake line 4 extends via an analogized separating valve 8, 8′ to the inlet valves 9 and 10 of wheel brakes 11 and 12. Return lines 13 and 14 extend from wheel brakes 11 and 12 to a low pressure accumulator 15. Outlet valves 16 and 17 are incorporated in the return lines 13 and 14. Inlet valves 9, 10 and outlet valves 16, 17 are electromagnetically operable two-way/two-position directional control valves. While the inlet valves are normally open, the outlet valves are normally closed. By way of a non-return valve 18, the low pressure accumulator 15 is connected to the suction side of the return pump 6 which latter connects with its pressure side to brake line 4 between the separating valve 8, 8′, on the one hand, and the inlet valves 9 and 10, on the other hand. Return pump 6 is of the self-priming type and has a suction line 19 leading to brake line 4 between master cylinder 1 and analogized separating valve 8, 8′. Inserted into suction line 19 is an electromagnetically operated change-over valve 20, 20′. It is closed in its de-energized condition and opened for pressure increase when the return pump 6 is required to aspirate pressure fluid from the supply reservoir 2 by way of brake line 4 and master cylinder 1.

Associated with each wheel of wheel brakes 11, 12, 23 and 24 is a revolution meter 29, 30, 31, 32. These revolution meters are used to meter the speed of the wheels, consequently, for determining a vehicle reference speed, for detecting vehicle standstill, and for slip detection.

The brake circuit allotment is optional, it may be a diagonal brake circuit allotment, with the wheel brakes of the right rear wheel and the left front wheel connected to brake circuit I, while brake circuit II feeds the wheel brakes of the right front wheel and the left rear wheel.

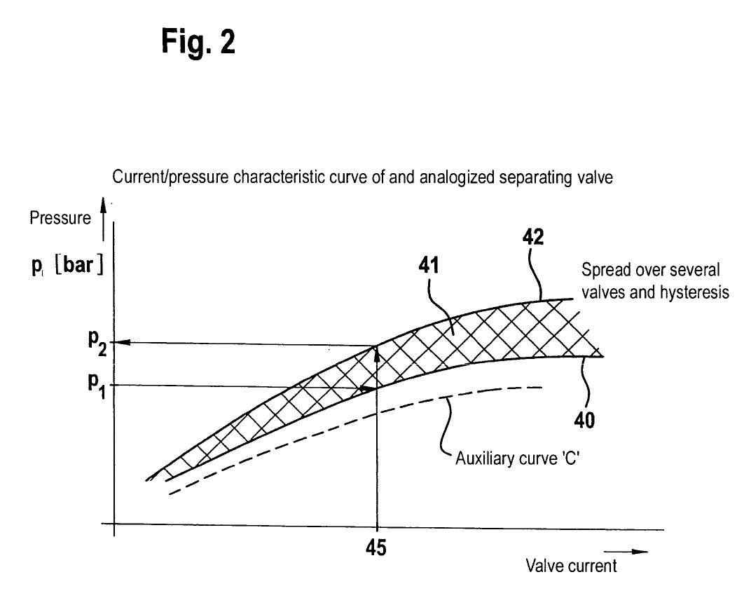

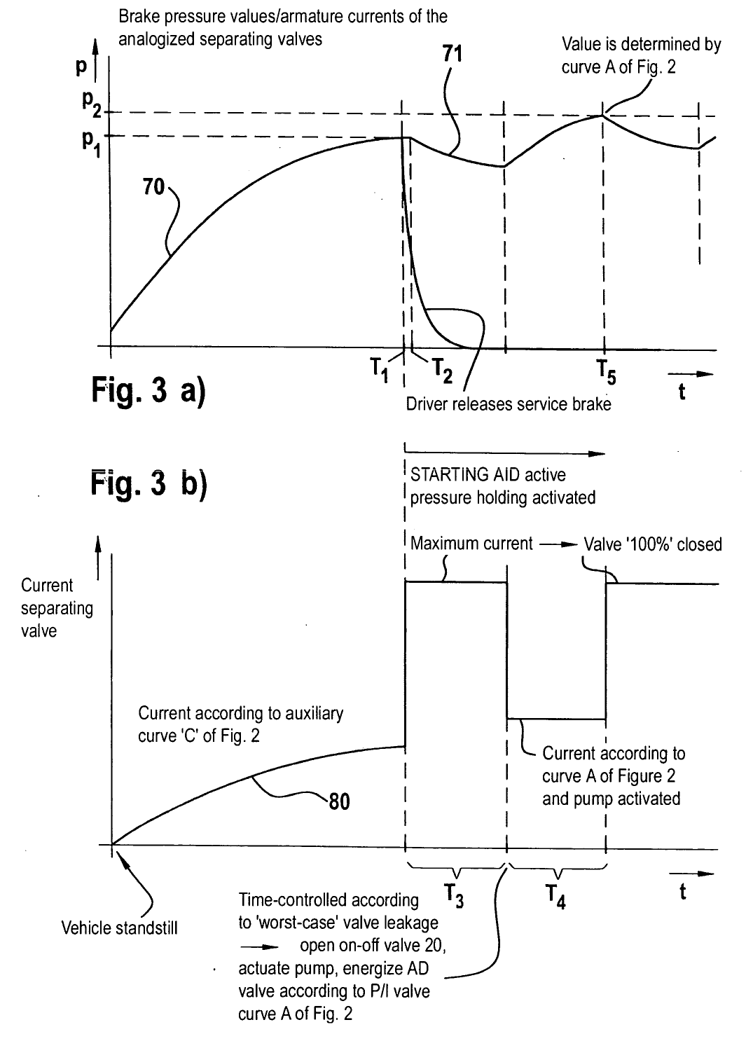

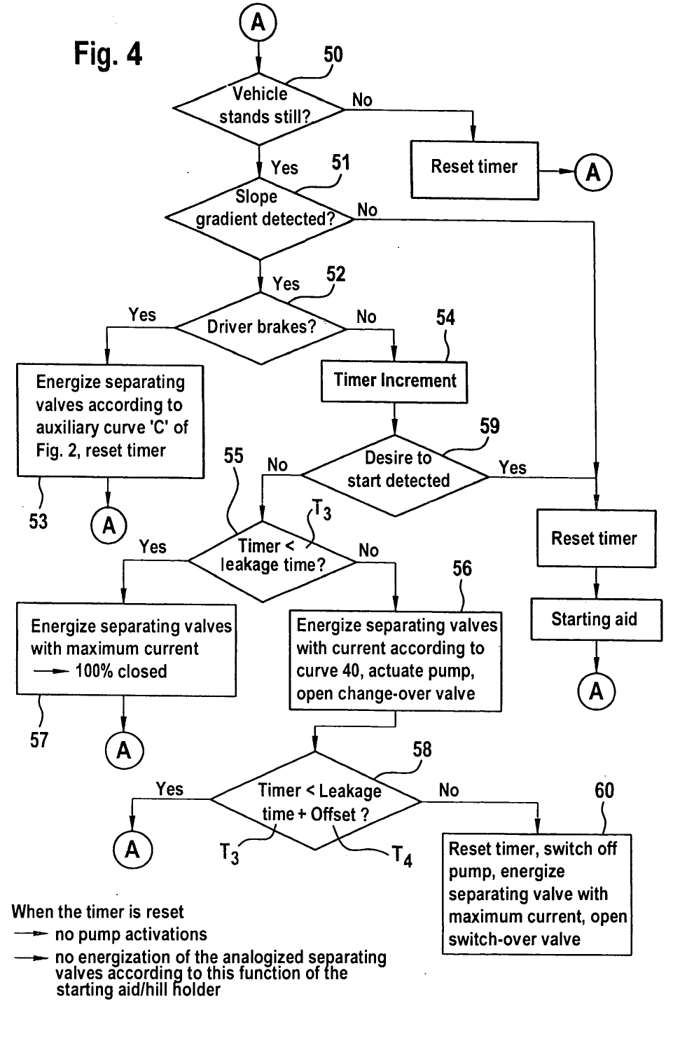

The two-circuit hydraulic brake system I, II operates as a starting aid that is controlled by actuating signals output by control device 33. Control device 33 comprises an accumulator 34, a counter 37, and a model 35 for calculating the leakage/pressure losses of the hydraulic components 6, 7, 8, 9, 10, 16, 20 as a function of time. As FIG. 4 shows, it is determined whether the vehicle stands still (lozenge 50), the gradient of the slope is detected (lozenge 51) and the driver is braking (lozenge 52). Consequently, the starting aid is only activated when the driver himself/herself moved the operable vehicle to standstill by means of the brake pressure p1 required to hold the vehicle. As this occurs, the pressure sensor 27 senses the holding brake pressure p1 that will be stored in the memory 34 and, thus, available as nominal holding brake pressure p1. Application of pedal 3 causes displacement of pressure fluid out of the master brake cylinder into the wheel brake cylinders 11, 12, 23, 24 by way of brake lines 4, 5. Each brake circuit I, II accommodates one actuatable analogized separating valve 8, 8′ that is normally open in its basic position and shuts off the brake lines 4, 5 relative to the master cylinder 1 in its switch position energized with the maximum actuating current. Each separating valve 8, 8′ is bridged by a bypass line with a non-return valve 21, 22 opening towards the wheel brakes and thus permitting braking upon application of the brake pedal even when the separating valve 8, 8′ is closed. The control device 33 acquires a holding situation detected by way of the signal of the brake light switch 26 or otherwise. The signals of the holding situation may also be determined from the signals of the wheel speed sensors 29-32 according to an embodiment. The gradient of the slope may be determined from the signals 36 of a longitudinal acceleration sensor as is known. As soon as the activation criteria in lozenges 50 and 51 of FIG. 4 are fulfilled, the starting aid will be activated. Thus, when the starting aid is activated, the application of brake pedal 3 is looked at in lozenge 53. When there is an application of brake pedal 3, the separating valves 8, 8′ will be energized in step 53 according to the actuating current/brake pressure characteristic curve C of FIG. 2 in order that the maximum brake pressure p1 adjusted by the driver can be shut up the brake immediately after time T1 at the time T2 (FIG. 3). As this occurs, the actuating current 60 lies so far beneath the current/pressure characteristic curve 40 (FIG. 2) that the driver does not feel any negative influence of the partly closed separating valves 8, however, the separating valves 8, 8′ can assume their shut position almost immediately when release of the brake pedal 3 is sensed.

When the signal 26 output by the brake light switch or any other device indicates that the brake pedal 3 is no longer applied by the driver, a counter 37 or timer will be started in step 54 for the first time upon entry into the control and is set upwards according to the limit value consideration ‘timer<leakage time’ until the leakage time shown in lozenge 55 is reached. As long as counter 37 (timer) has not yet reached the value Wₗᵢₘᵢₜ≧leakage time, the separating valves 8, 8′ are energized with the maximum actuating current in step 57. They will completely shut off the brake lines 4 or 5 towards the master brake cylinder. When counter 37 reaches or exceeds a predetermined value Wₗᵢₘᵢₜ or when the timer determines a time period during or after which a predetermined pressure loss needing adjustment has occurred due to leakage of the hydraulic components, the on-off valve 20, 20′ will be opened in step 56, the pump e.g. 6 actuated and the analogized separating valve 8, 8′ actuated by an actuating current that corresponds to the nominal holding brake pressure (curve 40 of FIG. 2). Analogized separating valve 8, 8′ will then act as an ‘adjustable pressure limiting valve’.

FIGS. 3 a) and b) show characteristic curves relating to the brake pressure values (FIG. 3a) and the actuating currents (FIG. 3b) of the separating valves 8, 8′ as a function of time t. While the driver introduces brake pressure (characteristic curve 70) into wheel brakes 11, 12, 23, 24 until a holding brake pressure p1 is reached, the control device 33 will energize the separating valves 8, 8′ according to the driver's brake pressure corresponding to characteristic curve 60 in such a manner that the passage of brake fluid through the separating valves 8, 8′ is limited only to such an extent that the driver cannot feel any effects on the brake pedal 3. As soon as the driver has reached the holding brake pressure p1 at time T1, the separating valves 8, 8′ will be energized maximally and thus closed at time T2 when the signal prevails indicating that the driver has released the brake. After a time period T3 which is determined according to the model-based calculation of the wheel pressure losses 71 due to leakage, the separating valves 8, 8′ are so actuated according to the actuating current/brake pressure characteristic curve 40 of FIG. 2 that they are energized by an actuating current 45 which corresponds to the holding brake pressure p1, when pump 6 or 7 is activated and change-over valves 20 opened. Due to the ‘pressure limiting function’ of the so adjusted separating valves 8, 8′ it is possible for a maximum holding brake pressure p2 to develop in the wheel brakes which is determined by the tolerance field 41 of the valves and is only slightly in excess of the holding brake pressure p1. Of course, it is also favorably feasible to always adjust the holding brake pressure p2 according to the characteristic curve 42. This may be done e.g. by an actuating current 45 (FIG. 2) in an invariable way or according to a value associated with a functional relationship.

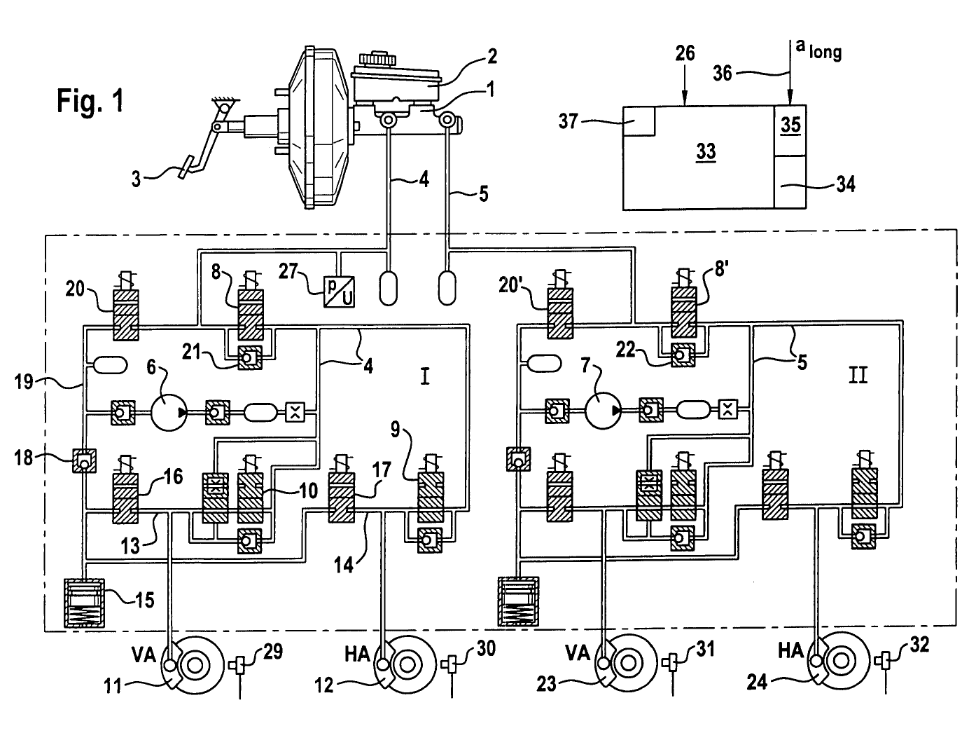

During the time period T4 in which the brake pressure is controlled to the holding brake pressure p1, p2, a poll is made in lozenge 58 whether the value of counter 37 is lower than the sum of leakage time T3 and brake pressure increase time T4 (offset). Beginning with start A ahead of lozenge 50 the polling in FIG. 4 is executed with a clock rate until the brake pressure is adjusted to the holding brake pressure p2 at time>T5. When the counter 37 reaches or exceeds the value Wₗᵢₘᵢₜ, counter 37 is reset in step 59, pumps 6, 7 are switched off, the separating valves 8, 8′ are energized by the maximum actuating current and thus closed, as illustrated in FIG. 1, and the change-over valve becomes de-energized and thus closed.

Should the slope gradient not be detected in lozenge 51 or should a desire to start be detected (lozenge 59), the counter will be reset, the starting aid function initiated, and return to start A executed in each case.

Favorably, the pressure losses due to leakage of the hydraulic components can be determined according to empirical specifications or model-based calculation. A differential brake pressure will be determined by way of a time function of the holding brake pressure or a comparison between the holding brake pressure and brake pressures read out from a table and reduced by the pressure losses. The holding brake pressure must be corrected by said differential brake pressure. This feature enables the starting aid assistance with a standard ESP hydraulics without additional pressure sensors even for longer periods of time (minute range). Also, the pressure holding/vehicle holding for a longer interval permits automated holding of the vehicle by means of an electric parking brake. Thus, it is possible to activate the electric parking brake in an automated fashion e.g. after a pressure holding time of more than three minutes (waiting time in front of traffic lights).

1. Method for holding a vehicle on an incline by metering brake pressure into the wheel brakes of a brake system, characterized by the following steps:
a) determining the brake pressure (p1) required to hold the vehicle.
b1) determining a time period dt according to a reduction of the brake pressure, in particular due to leakage of the brake system starting from the release of the brake pedal (3), or
b2) comparing the determined brake pressure with the actual brake pressure starting from the release of the brake pedal (3), and
c) increase of the brake pressure in the wheel brakes by
c1) switching on a pressure generator (6, 7)
c2) opening the change-over valve (20, 20′)
c3) controlling a valve (8, 8′) in such a fashion that at least the brake pressure (p1, p2) required to hold the vehicle will develop in the wheel brakes.

2. Method as claimed in claim 1,
characterized in that for determining the brake pressure (p1) necessary to hold the vehicle, the brake pressure that is introduced by the driver into the wheel brakes by way of brake pedal application (3) or by way of an independent pressure source (active booster, pump (6, 7) or a like component) is sensed by a pressure sensor (27) or estimated by way of a model.

3. Method as claimed in claim 1 or 2,
characterized in that the brake pressure is stored in an electric or electronic memory (35).

4. Method as claimed in any one of claims 1 to 3,
characterized in that the release of the brake pedal (3) is detected.

5. Method as claimed in any one of claims 1 to 4,
characterized in that the brake pressure reduced in the wheel brakes is re-increased in the wheel brake within a time period that is in a functional relationship to the necessary holding brake pressure (p1).

6. Method as claimed in any one of claims 1 to 5,
characterized in that at least one analog or analogized valve (8, 8′) is so controlled towards the holding brake pressure (p1) during the increase of the brake pressure by way of the activated pressure generator (6, 7) that the brake pressure (p1, p2) introduced into the wheel brakes lies at or above the bottom valve current/pressure characteristic curve (40) and within the deviation predetermined by a tolerance field (41) of the analog or analogized valve (8, 8′).

7. Method as claimed in claim 6,
characterized in that a maximum brake pressure (p2) introduced into the wheel brakes is adjusted in accordance with the top valve current/pressure characteristic curve (42) of the tolerance field (41) of the analog or analogized valves (8, 8′).

8. Use of an analog or analogized separating valve (8, 8′) as a controllable pressure limiting valve in a brake system for vehicles, preferably for implementing a method as claimed in any one of claims 1 to 7.

9. Starting aid for holding a vehicle on an incline, comprising a pedal-operated master cylinder (1) and at least one wheel brake (11, 12, 23, 24) connected to the master brake cylinder (1) by way of a brake line (4, 5), wherein application of pedal (3) causes displacement of pressure fluid out of the master brake cylinder into the wheel brake cylinder by way of the brake line, and wherein an inlet valve (9, 10) is incorporated into the brake line that is normally open in its basic position and shuts off the brake line in its switch position, and a separating valve (8, 8′) interposed between the inlet valve (9, 10) and the master brake cylinder that is open in its basic position and closes the brake line in its switch position and is bridged by a bypass line with a non-return valve opening towards the brake line (4, 5), and a pump (6, 7) having its pressure side connected to the brake line and its suction side connected to the master brake cylinder by way of an on-off valve (20, 20′), and an electronic control device (33) for actuating the valves (8, 8′, 9, 10, 16, 17) and the pumps (6, 7) according to a program,
characterized in that the separating valve (8, 8′) is configured as an analog or analogized valve and can be actuated by way of an actuating current in such a fashion that it is adjustable according to a functional relationship (P/I) at least to a brake pressure (p1, p2) lying on the holding brake pressure (p1) in dependence on a holding brake pressure (p1) determined on a slope upon release of the pedal.

10. Starting aid as claimed in claim 9,
characterized by determining the holding brake pressure (p1) in a model (35) to which are sent, as an input quantity, the signals (36) of a longitudinal acceleration sensor.

11. Starting aid as claimed in claim 9,
characterized by determining the holding brake pressure (p1) by means of a pressure sensor (27) sensing the brake pressure introduced by the driver into the wheel brake(s) when holding the vehicle.

12. Starting aid as claimed in claim 9 or 11,
characterized in that the holding brake pressure (p1) is stored in a memory (34) and, upon release of the pedal (3), is compared with brake pressures (p_{red}) stored in a table and representing the brake pressures reduced by the leakage losses, and in that the pump (6, 7) is switched on, the on-off valve (20, 20′) is opened, and the analog or analogized separating valve (8, 8′) is adjusted to the holding brake pressure (p1, p2) when the reduced brake pressure (p_{red}) has reached a predetermined value.

13. Starting aid as claimed in any one of claims 9 to 11,
characterized in that the control unit (33) includes a timer or counter (37), in that the value of the timer or counter (37) is increased starting from release of the brake pedal (3) and that the pump (6, 7) is switched on, the on-off valve (20, 20′) is opened, and the analog or analogized separating valve (8, 8′) is adjusted to the holding brake pressure (p1, p2) when the timer or counter (37) has reached or exceeded a predetermined value (wₗᵢₘᵢₜ).

14. Starting aid as claimed in any one of claims 9 to 13,
characterized in that the magnitude of the value (wₗᵢₘᵢₜ) is predetermined in response to the holding brake pressure.
